(19) United States
(12) Patent Application Publication
(10) Pub. No.: US 2019/0047581 A1
(43) Pub. Date: Feb. 14, 2019

(54) METHOD AND APPARATUS FOR SUPPORTING MISSION-CRITICAL APPLICATIONS VIA COMPUTATIONAL CLOUD OFFLOADING

(71) Applicant: GM GLOBAL TECHNOLOGY OPERATIONS LLC, Detroit, MI (US)

(72) Inventors: Fan Bai, Ann Arbor, MI (US); Soheil Samii, Royal Oak, MI (US); Massimo Osella, Troy, MI (US)

(21) Appl. No.: 15/676,299

(22) Filed: Aug. 14, 2017

(51) Int. Cl. B60W 50/06; G06F 9/50

(52) U.S. Cl. CPC B60W 50/06; G06F 9/5027; G06F 9/5055; G06F 2209/503; G06F 2209/501; B60W 2050/065; G06F 2209/509

(57) ABSTRACT

A vehicle, a computer system for driving the vehicle and a method of operating the vehicle. The vehicle includes an embedded processor. The embedded processor receives an instruction to perform a computational task involving an operation of the vehicle and offloads the computer task to a remote processor. The remote processor receive the offloaded computational task from the embedded processor, performs the computational task to obtain a partial result, and provide the partial result to the embedded processor. The embedded processor performs the computational task starting with the partial results provided by the remote processor.

### INTRODUCTION

The subject disclosure relates to a system and method for performing computational tasks involved in operating a vehicle, and in particular, a system and method for sharing computational tasks involved in operating the vehicle between multiple processors.

An embedded processor of a vehicle performs the various computational operations involved in operating the vehicle. Some computational operations can be highly mission-critical, such as object perception and sensing operations, vehicle dynamic control (e.g., braking, steering, propulsion), etc. Other computational operations such as entertainment applications, gesture control for dashboard operations, route planning, etc., are not critical to the operation of the vehicle and can be performed when the embedded processor has available resources. Due to the life cycle of vehicles, an embedded processor can be required to operate for 10 to 15 years. Over this time period, it is expected that technologies and programs will be created that exceed the current capacity of the embedded processor. Accordingly, it is desirable to provide a method for offloading certain computational tasks from the embedded processor to a remote processor to ensure safe and uninterrupted operation of the vehicle.

### SUMMARY

In one exemplary embodiment, a method of operating a vehicle is disclosed. The method includes receiving, at an embedded processor of the vehicle, a computational task involving an operation of the vehicle, offloading the computational task from the embedded processor to the remote processor, performing the computational task at the remote processor to obtain a partial result, providing the partial result to the embedded processor, and performing the computational task at the embedded processor starting with the partial result provided by the remote processor.

The method further includes determining, at the embedded processor, a quality-of-service metric for the computational task, determining, at the embedded processor, an execution parameter for performing the computational task at a remote processor, and offloading the computational task from the embedded processor to the remote processor when the execution parameter of the remote processor meets the quality-of-service metric for the computational task. When the execution parameter of the remote processor does not meet the quality-of-service metric for the computational task, the computational task is performed at the embedded processor.

The quality-of-service metric is at least one of a reliability metric, a latency metric, and an accuracy metric for the computational task. In some embodiments, determining the execution parameter of the remote processor includes determining a latency of a communication link between the embedded processor and the remote processor. Additionally, the computational task is performed at the embedded processor when an execution parameter of the remote processor fails to meet the quality-of-service metric for the computational task while the remote processor is performing the computational task.

In another exemplary embodiment, a computer system for driving a vehicle is disclosed. The computer system includes an embedded processor of the vehicle and a remote processor. The embedded processor of the vehicle is configured to receive a computational task involving an operation of the vehicle, and offload the computational task. The remote processor is configured to receive the offloaded computational task from the embedded processor, perform the computational task to obtain a partial result, and provide the partial result to the embedded processor. The embedded processor is further configured to perform the computational task using the partial result provided by the remote processor.

The embedded processor is further configured to determine a quality-of-service metric for the computational task, determine an execution parameter for performing the computational task at the remote processor, and offload the computational task to the remote processor when the execution parameter of the remote processor meets the quality-of-service metric for the computational task. When the execution parameter of the remote processor does not meet the quality-of-service metric for the task, the embedded processor is configured to perform the computational task itself.

The quality-of-service metric includes at least one of a reliability metric, a latency metric, and an accuracy metric for the computational task. The execution parameter of the remote processor includes a latency of a communication link between the embedded processor and the remote processor. The embedded processor performs the computational task when an execution parameter of the remote processor fails to meet the quality-of-service metric for the computational task while the remote processor is performing the computational task. In various embodiments, the remote processor is a cloud server, a portable processor being carried within the vehicle and/or an embedded processor of another vehicle.

In yet another exemplary embodiment, a vehicle is disclosed. The vehicle includes an embedded processor. The embedded processor is configured to receive an instruction to perform a computational task involving an operation of the vehicle, offload the computer task to a remote processor, receive a partial result of the computational task from the remote processor, and perform the computational task starting with the partial result provided by the remote processor.

The embedded processor is further configured to determine a quality-of-service metric for the computational task, determine an execution parameter of a remote processor for performing the computational task at the remote processor, and offload the computational task to the remote processor when the execution parameter of the remote processor meets the quality-of-service metric for the computational task. The embedded processor is further configured to perform the computational task when the execution parameter of the remote processor does not meet the quality-of-service metric for the computational task.

The quality-of-service metric includes at least one of a reliability metric, a latency matric, and an accuracy metric for the computational task. The execution parameter of the remote processor includes a latency of a communication link between the embedded processor and the remote processor. The embedded processor quantifies a mission-criticality of the computational task to the vehicle and offloads the computational task when the associated mission-criticality meets a selected criterion. In various embodiments, the remote processor is a cloud server, a portable processor being carried within the vehicle and/or an embedded processor of another vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an exemplary computer system that facilitates operation of a vehicle;

FIG. 2 shows a schematic diagram showing details of the computer system of FIG. 1;

FIG. 3 shows a graph of sensing error to latency for a run-to-complete task;

FIG. 4 shows a graph of sensing error to latency for a non-run-to-complete task;

FIG. 5 shows an illustrative “fish-eye” effect of progressively computing a non-run-to-complete task;

FIG. 6 shows a flowchart illustrating a decision process for offloading a computational task to a remote processor in one embodiment; and

FIG. 7 shows a flow chart illustrating a decision process for performing a task in the event of a failure occurring with respect to performing the task at a remote processor.

### DETAILED DESCRIPTION

The following description is merely exemplary in nature and is not intended to limit the present disclosure, its application or uses. It should be understood that throughout the drawings, corresponding reference numerals indicate like or corresponding parts and features.

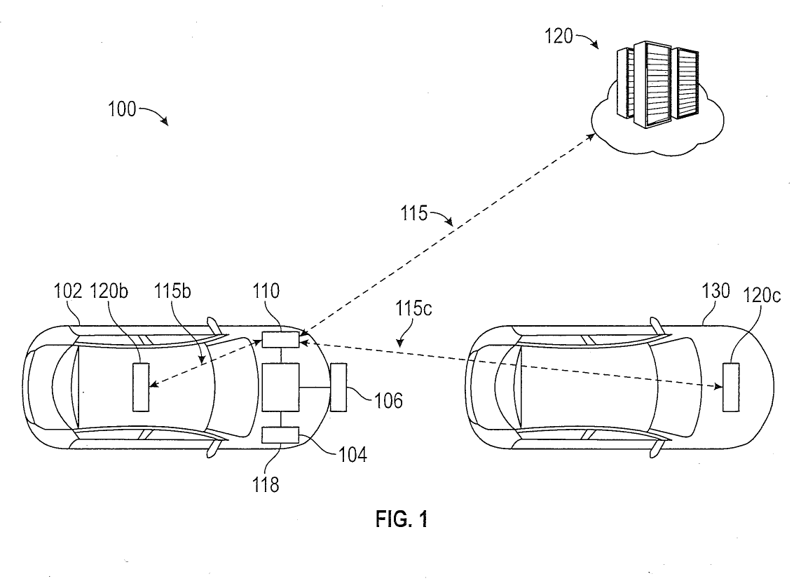

In accordance with an exemplary embodiment of the disclosure, FIG. 1 illustrates an exemplary computer system 100 that facilitates operation of a vehicle 102. The computer system 100 includes the vehicle 102 in communication with a remote processor 120 over a communication link 115. The vehicle 102 can be a vehicle that is operated by a driver or can be a self-driving or autonomous vehicle. The vehicle 102 includes a processor, referred to herein as an embedded processor 104, that executes various computer programs, computer functions or computer tasks related to operating the vehicle 102.

The vehicle 102 further includes one or more environmental sensors 106 that can obtain various measurements about the environment of the vehicle 102 such as the range and velocity of various objects in the vehicle's surrounding environment. These environmental sensors 106 can include, for example, radar, LIDAR, and cameras that can be used to measure range, orientation and/or velocity of various objects with respect to the vehicle 102. The vehicle 102 further includes one or more internal state sensors 108 for obtaining measurements concerning the internal operations of the vehicle 102 or of vehicle components. For example, an internal state sensor 108 may include a brake sensor, acceleration sensor, a sensor determining a rotation of the steering wheel, or other sensor that sensing a parameter involved with basic operation of the vehicle, such as propulsion, braking, steering, etc. The internal state sensor 108 may further measure less mission-critical aspects of the vehicle 102, such as route mapping and planning, entertainment systems, air conditioning levels, etc. In one embodiment, the data obtained by the environmental sensors 106 and by the internal state sensors 108 are sent to the embedded processor 104, which processes the data in order to determine an action to be taken by the vehicle 102 and then implements that action at the vehicle 102.

Vehicle 102 further includes a communication module 110 that provides the communication link 115 between the embedded processor 104 and the remote processor 120. The remote processor 120 can be a remote server, commonly referred to a cloud computer or a “cloud”. The communication link 115 can be any suitable wireless communication channel, such as a cellular communication channel, radio-frequency communication channel, etc. In another embodiment, the remote processor can be a processor 120b of a portable device such as a laptop, tablet, smartphone, or other portable device that may be carried within a cabin of the vehicle 102. A short-range communication link 115b, such as a Bluetooth communication link or wireless communication link can be used for data communication between the embedded processor 104 and the portable device 120b. In yet another embodiment, the remote computer 120 can be a processor 120c of another vehicle 130, whereas the embedded processor 104 and the remote processor 120c communicate over a communication link 115c between the vehicle 102 and the other vehicle 130. In various embodiments, the communication link 115c between the vehicle 102 and the other vehicle 130 is a visual light communication channel.

The demands on the embedded processor 104 can vary depending on the type of vehicle 102 as well as the criticality of a particular computational task. The more critical the task is to safe operation of the vehicle 102, the greater the demand for a high quality-of-service from the embedded processor 104. Tasks can be categorized based on the quality-of-service requirements that the task makes on the embedded processor 104 or on any processor that performs the task. Mission-critical tasks place high quality-of-service requirements on the processor. Semi-mission-critical tasks place medium quality-of-service requirements on the processor. Opportunistic tasks place low quality-of-service requirements on the processor. Other categories of tasks defining other quality-of-service requirements on the processor can also be used although they are not explicitly discussed herein.

Mission-critical tasks include, for example, perception tasks such as detecting other vehicles and pedestrians; sensor fusion for correlating signals from different sensors; tasks such as braking, steering, propulsion functions, etc., that provide dynamic control of the vehicle; short-term trajectory planning; and short-term determination of drivable space of the vehicle 102.

Semi-mission-critical tasks can include, for example, long-term planning (e.g., trajectory planning for a next or upcoming road segment); long-term drivable space determination based on objects already sensed by other vehicles or by static objects embedded in detailed maps; long-term tactical driving decisions such as lane changes and turns, based on inputs from the in-vehicle embedded domain; static route planning at the start of an automated driving session, based on map information; dynamic route adjustment; continuous calculation of a safe state of the vehicle (which can be partially based on inputs from embedded vehicle perception functions); safety monitoring (e.g., continuous check to validate the correctness of the control application) and monitoring the status of the driver.

Opportunistic tasks include, for example, infotainment/entertainment application offloading; and action recognition and gesture control, which allows a driver to perform a gesture at an interface of the vehicle, such as in order to select a radio station.

In order that the embedded processor 104 is able to provide high quality-of-service to mission-critical tasks, the present disclosure provides a method of sharing tasks between the embedded processor 104 and another processor, such as cloud computer 120. The method partitions tasks suitably between the embedded processor 104 and the remote processor 120 so that mission-critical tasks for operation of the vehicle are executed without interruption. The criticality of a task can be quantified by quality-of-service metrics associated with the task. Exemplary quality-of-service metrics include reliability (a), latency (t) and accuracy (c). Various computational tasks and their quality-of-service metrics are discussed herein.

Perception tasks detect static and moving objects in the range of the environmental sensors of the vehicle 102. These tasks are time-critical for determining a short-term trajectory of the vehicle 102 and to control various control components of the vehicle 102 in order to provide a safe motion of the vehicle. Perception tasks have low latency (t) requirements, meaning that the perceptions tasks need to be executed quickly and with little or no delay. The perception tasks further require a high level of reliability (a) and a high level of accuracy (c).

Short-term trajectory planning determines the immediate trajectory to be followed by the vehicle. The trajectory that is determined by this short-term planning considers the existing context of the environment (i.e., the existence of static and/or moving objects). This task is generally executed with a high frequency relative to its long term counterparts, discussed herein. Short-term trajectory planning tasks require a low latency (τ), a high level of reliability (α) and a high level of accuracy (ε).

Long-term trajectory planning plans routes and trajectories for the distances beyond the range of the vehicle perception and sensing suite. Long-term trajectory planning does not consider the objects detected in the range of the vehicle sensors, but rather uses high definition maps with static object and lane information and may also use information about moving objects or newly-detected static objects detected by other vehicles. When the vehicle is within range of objects determined during the long-term trajectory planning, the short-term planning may adjust results of the long-term planning in order to provide safe driving. Long-term trajectory planning tasks allow for a high latency (τ), but require a medium level of reliability (α) and a medium level of accuracy (c).

Safe state calculation tasks calculate a safe state of the vehicle and determines how to reach a safe state in case it is needed (e.g., “safe trajectory”). Safe state calculations tasks are similar to long term planning tasks. However, the safe state calculation tasks plan for what to do in case of a component failure or system malfunction. Safe state calculations can, for example, involve computations that determine a “minimal risk condition.” A minimal risk condition is a terminology standard for automated, autonomous and self-driving vehicles defined for Level 4 (high automation) and Level 5 (full automation) in SAE International J3016. Safe state calculation tasks allow for a high latency (τ), require a high level of reliability (α) and require a high level of accuracy (c).

Vehicle dynamic control tasks provide longitudinal and lateral control of the vehicle to follow the trajectory provided by the short-term trajectory planner or, in case of failures or malfunctions, by the safe state trajectory. The vehicle dynamic control tasks consider the objects detected by the perception tasks. Vehicle dynamic control tasks require low latency (τ), a high level of reliability (α) and a high level of accuracy (c).

Due to the relative importance of mission-critical tasks, these tasks are likely to be performed at the embedded processor 104 in order that they may be completed in a timely manner. Sending such tasks to a remote processor can introduce delays and reliability issues that may contribute to poor performance of the tasks. On the other hand semi-mission-critical tasks and opportunistic tasks can be performed at a remote processor without interfering with the performance of these tasks, depending on several parameters.

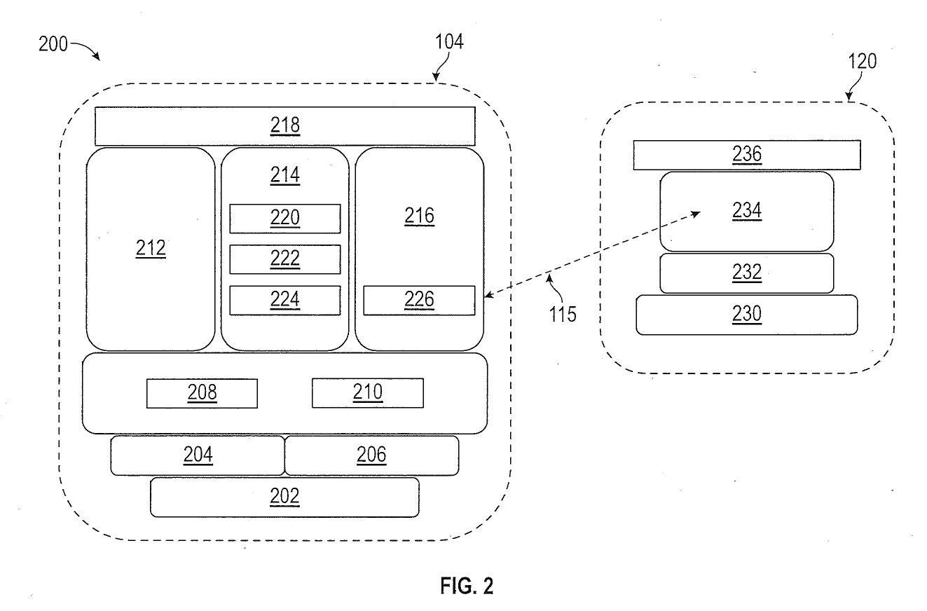

FIG. 2 shows a schematic diagram 200 showing details of the computer system 100 of FIG. 1. The computer system includes the local or embedded processor 104 and the remote processor 120 communicating over communication channel 115.

The embedded processor 104 operates a suitable operating system 202 executable on the embedded processor 104. The operating system 202 runs a local virtual machine 204 to emulate an operating system for performing operations at the vehicle 102 and a remote virtual machine 206 to emulate an operating system compatible with the operating system 230 of the remote processor 120. An Admission Control Module 208 and a Resource Allocation Module 210 are run on the virtual machines 204 and 206. The Admission Control Module 208 evaluates whether a task being requested can be accomplished by the current available resources. If not, the task being requested can be directly rejected by the Admission Control Module 208 without further processing. If the Admission Control Module 208 determines that the task being requested can be accomplished using available resources, the system conducts the next steps and passes the task to the Resource Allocation Module 210. The Resource Allocation Module 210 decides whether a computational task that has been received at the embedded processor 104 can be offloaded to the remote processor 120. The Resource Allocation Module 210 can make a static decision or a dynamic decision. The static decision is based on a pre-determined rule concerning resource and/or data allocation. A dynamic decision may take into consideration such elements as the current quality of the connection between the embedded processor 104 and the remote processor 120, the criticality of the computer task for operating the vehicle 102, the availability of resources at the embedded processor 104, the availability of resources of at the remote processor 120, etc.

The layer above the Admission Control Module 208 and the Resource Allocation Module 210 includes a Local Execution Manager 212, a Quality-of-Service (QoS) Manager 214 and a Runtime Offloading Manager 216, which work together below an application abstraction layer 218. The Local Execution Manager 212 performs the input and output of computational tasks and the execution of locally-performed computational tasks.

The QoS manager 214 profiles various connectivity metrics between the embedded processor 104 and the remote processor 120. The QoS Manager 214 includes an application profiler 220, a CPU profiler 222 and a network estimator 224. The application profiler 220 tracks the quality-of-service metrics of various computer tasks/applications. The CPU profiler 222 monitors the resources of the embedded processor 104 in order to be able to determine the ability of the embedded processor 104 to effectively process a selected task/application. The network estimator 224 tracks connectivity metrics of various communication links such as data rate, connection stability, channel latency, etc.

The Run-Time Offloading Manager 216 executes a decision process in order to determine which tasks are to be performed by the local execution manager 212 of the embedded processor 104 and which can be offloaded to the remote processor 120. When a task can be offloaded to the remote processor 120, the Runtime Offloading Manager 216 sends the tasks to the remote processor 120 using communication module 226.

The remote processor 120 includes operating system 230 running a suitable virtual machine emulator 232. An offloading server 234 running on the virtual machine receives the task from the embedded processor 104, executes a task received from the embedded processor 104 and sends the task back to the embedded processor 104. In various embodiments, the remote processor 120 can send the task back as a completed task or as a partially completed task. The remote processor 120 further includes an application abstraction layer 236.

The tasks performed at the embedded processor 104 can be either a run-to-complete task or a non-run-to-complete task. A run-to complete task generally includes mission-critical tasks, such as sensing, perception, and vehicle control tasks. Such tasks are either to be run until they are completed or not to be run at all. The Run-Time Offloading Manager 216 decides whether a certain mission-critical task can be assigned to the remote processor 120 based on various quality-of-service metrics for the task, such as latency (τ), reliability (α) and estimated error (ε). Determination of various execution parameters required for a task are shown in Eqs. (1)-(3), respectively, below:

$$\begin{matrix}{l}_{j}^{( i )} = {a}_{( i , j )} {t}_{j}^{( i )} + ( 1 - {a}_{( i , j )} ) ( \frac{{w}_{j , u}^{( i )}}{{R}_{u}} + \frac{{w}_{j , d}^{( i )}}{{R}_{d}} + {\hat{t}}_{j}^{( i )} ) < τ & Eq . ( 1 ) \\ {S}_{j}^{( i )} = {a}_{( i , j )} {R}_{j}^{( i )} + ( 1 - p ) ( 1 - {a}_{( i , j )} ) {\hat{R}}_{j}^{( i )} > α & Eq . ( 2 ) \\ {e}_{j}^{( i )} = {a}_{( i , j )} {e}_{j}^{( i )} + ( 1 - {a}_{( i , j )} ) {\hat{e}}_{j}^{( i )} < ɛ & Eq . ( 3 )\end{matrix}$$

In Eq. (1), lⱼ⁽ⁱ⁾ is an expected value of latency for computing the i^{th} task (on either the embedded processor or the remote processor). The estimated computational latency for performing the i^{th} task at the embedded processor is given as tⱼ⁽ⁱ⁾. Therefore, the first term on the right hand side of Eq. (1) calculates the expected latency if the i^{th} task is executed exclusively at the embedded processor. The estimated computational latency for performing the i^{th} task at the remote processor is given by \hat{t}ⱼ⁽ⁱ⁾. The term

$$\frac{{w}_{j , u}^{( i )}}{{R}_{u}}$$

is the estimated latency for uploading the data volume w_{j,u}⁽ⁱ⁾ for the i^{th} task through an upload cellular link having bandwidth Rᵤ. The term

$$\frac{{w}_{j , d}^{( i )}}{{R}_{d}}$$

is the estimated latency for downloading the data volume w_{j,d}⁽ⁱ⁾ for the i^{th} task through a download cellular link having bandwidth R_{d}. The second term on the right hand side of Eq. (1) therefore calculates the expected latency if the i^{th} task is executed exclusively at the remote processor. The variable a_{(i,j)} is a binary number (i.e., takes on the values of either 0 or 1) that selects which processor performs the calculations. A value of a_{(i,j)}=1 signifies that the task is performed on the local or embedded processor. A value of a_{(i,j)}=0 signifies that the task is performed on the remote processor. When the expected value of latency for the processor(s) is less than the latency requirement for the task (i.e., lⱼ⁽ⁱ⁾<τ for all a_{(i,j)}), then it can be determined that there is enough latency available to accommodate processing the i^{th} task on either the embedded processor or the remote processor.

In Eq. (2), Sⱼ⁽ⁱ⁾ is an expected system reliability for performing the i^{th} task by either the embedded processor or the remote processor. The estimated reliability when performing the i^{th} task at the embedded processor is given as Rⱼ⁽ⁱ⁾ Therefore, the first term on the right hand side of Eq. (2) calculates the reliability provided when the i^{th} task is executed exclusively at the embedded processor. The estimated computational latency for performing the i^{th} task at the remote processor is given by \hat{R}ⱼ⁽ⁱ⁾. The variable p is a value indicating a probability of a failure of a connection to the remote processor. Therefore, the second term on the right hand side of Eq. (2) calculates the reliability provided when the ith task is executed at the remote processor. When the expected processor reliability is greater than the required reliability of the task (i.e., Sⱼ⁽ⁱ⁾>α for all a_{(i,j)}), then it can be determined that there is enough reliability between the embedded processor and the remote processor to perform the i^{th} task.

In Eq. (3), εⱼ⁽ⁱ⁾ is an expected estimated error which can be due, for example, to sensing/detection errors that occur in sending/capturing data to a local/remote processor. The estimated error when performing the i^{th} task at the embedded processor is given as eⱼ⁽ⁱ⁾. The estimated error for performing the i^{th} task at the remote processor is given by êⱼ⁽ⁱ⁾. When the expected processor error is less than the required accuracy of the task (i.e., εⱼ⁽ⁱ⁾>α for all a_{(i,j)}), then it can be determined that there is enough accuracy provided by the embedded processor and the remote processor to perform the i^{th} task.

If the value of the execution parameters (lⱼ⁽ⁱ⁾, Sⱼ⁽ⁱ⁾, εⱼ⁽ⁱ⁾) satisfies the quality-of-service metrics (τ, α, ε) for a_{(i,j)}=1 (i.e., if lⱼ⁽ⁱ⁾<τ, Sⱼ⁽ⁱ⁾>α, and εⱼ⁽ⁱ⁾>ε for a_{(i,j)}=1), then the task can be sent to and executed at the remote processor. Otherwise, the task is sent to and executed at the embedded processor.

The prediction of the local execution tuple (lⱼ⁽ⁱ⁾Rⱼ⁽ⁱ⁾, eⱼ₍ᵢ₎) and the remote execution tuple (\hat{l}ⱼ⁽ⁱ⁾\hat{R}ⱼ⁽ⁱ⁾, êⱼ⁽ⁱ⁾) are estimated by profiling prior task executions at the embedded and remote processors. The local execution tuple and the remote execution tuple can be updated online based on results of prior remote execution. It can also be parameterized based on the operating environment as that is correlated to connectivity.

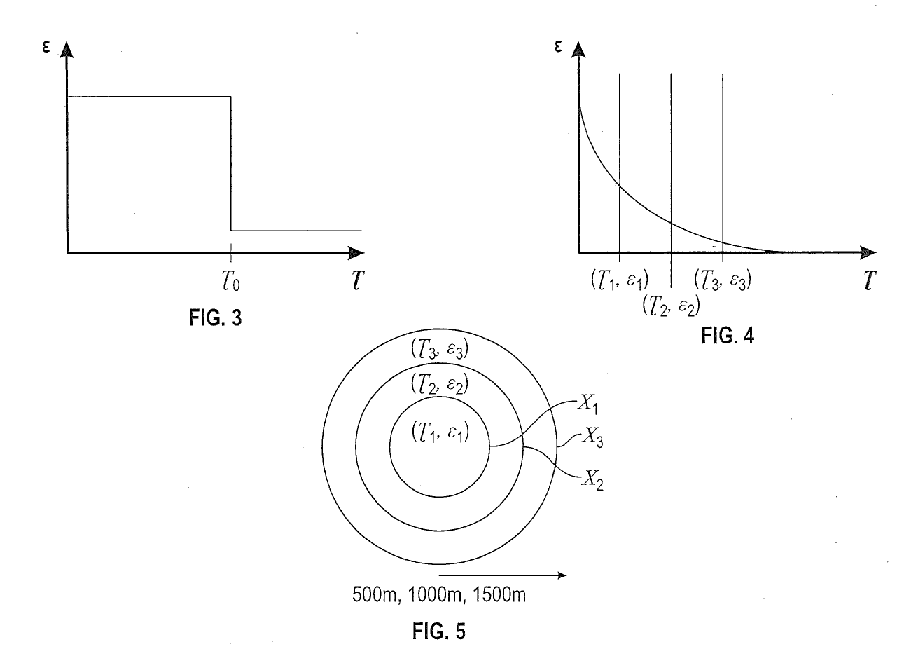

FIG. 3 shows a graph of sensing error to latency for a run-to-complete task. A run-to-complete task requires that the task be completed without pause. For a time period up until the execution time τ₀ for the task, the error parameter for the task is at a high value. After the execution time τ₀ (i.e., after the task has been completed), the error parameter drops to zero or a minimal value. Due to these requirements of run-to-complete tasks, these tasks are often run on the embedded processor.

FIG. 4 shows a graph of sensing error to latency for a non-run-to-complete task. A non-run-to-complete task can be paused at various times during the execution of the task. The sensing error decreases with time as shown by pairs (τ₁, ε₁), (τ₂, ε₂) and (τ₃, ε₃). These tasks can be performed progressively or in stages and the processor can stop or be halted at any time or at the end of certain stages during the execution of the task. The longer one can go without pausing the task, the better the sensing error for the task. Additionally, when the task is resumed, the quality of the results can be improved from its previous values by further processing.

For autonomous driving, many computer tasks can be designed as non-run-to-complete tasks. Such tasks include long-term path planning, long-term tactical driving session planning, long-term route adjustment, etc. These tasks tend to produce results that are not needed immediately. However, if a general solution (such as a general long-term route instructions) can be computed at an earlier time (i.e., at time τ₁ vs. τ₃), then such general solution may be acceptable. At later times, the specific solution can be provided to the driver or vehicle. In case of connectivity outage or cloud computer failure, the embedded controller has sufficient time, based on the last computed values, to reach a safe state, which for Level 2 or 3 driving automation systems involves requesting the human driver to take over full control of the vehicle, and for Level 4 and 5 systems involves a changing a mode in the system to reach a minimal risk condition.

FIG. 5 shows an illustrative “fish-eye” effect of progressively computing a non-run-to-complete task. At the end of a first computational stage x₁ occurring at time τ₁, the processor may provide good results (e.g., route planning) within a first radius (e.g., 500 meters). At the end of a second computational stage x₂ occurring at time τ₂, the processor may provide good results within a second radius (e.g., 1000 meters) greater than the first radius. At the end of a third computation stage x₃ occurring at time τ₃, the processor may provide good results within a third radius (e.g., 1500 meters) greater than the second radius. Thus, with each successive stage, the distance having good results grows to greater radii.

In one embodiment, the remote processor 120 can process the task in stages to obtain preliminary or partial results at the end of each stage. When the remote processor 120 gets to the end of a selected stage, it can provide the preliminary or partial results from that stage to the embedded processor 104 and the embedded processor 104 can continue the processing at the vehicle 102, using the preliminary or partial results and continuing the processing from the point at which the preliminary or partial results were obtained. The remote processor 120 therefore continuously provides preliminary or partial results to the embedded processor 104. As each successive stage is reached at the remote processor 120, the remote processor 120 provides the preliminary or partial results for the successive stage to the embedded processor 104, which then processes the received partial results. Given enough time, the embedded processor 104 can process the task to completion. In this manner, the heavy computations are offloaded from the embedded processor 104 to the remote processor 120. This offloading reduces or minimizes the amount of computations performed at the embedded processor 104, thereby freeing the computing and memory capacity at the vehicle 102.

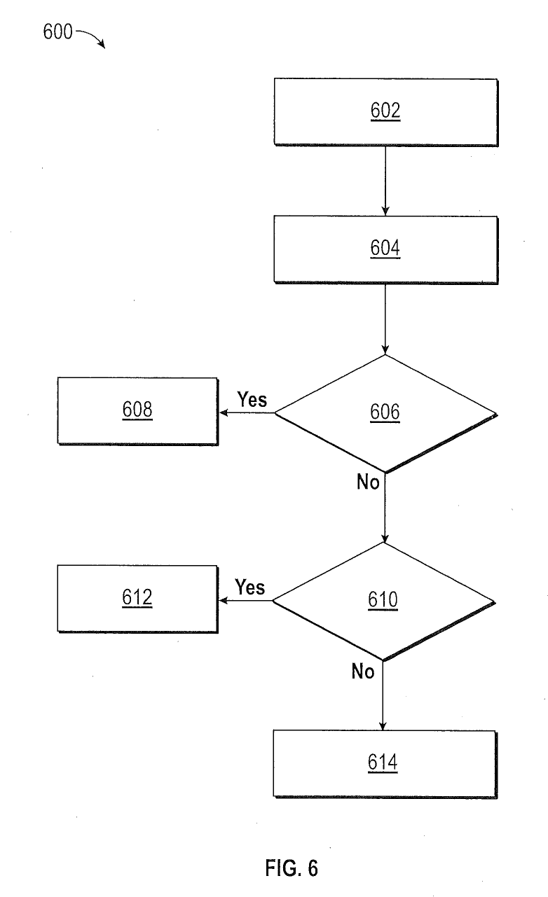

FIG. 6 shows a flowchart 600 illustrating a decision process for offloading a computational task to a remote processor in one embodiment. In box 602, a quality-of-service metric (τ, α, ε) is determined for the computational task. In box 604, execution parameters (lⱼ⁽ⁱ⁾, Sⱼ⁽ⁱ⁾, εⱼ⁽ⁱ⁾) for the processors are determined. This determination can use analysis of existing data on previous executions of the task, and may include variable metrics such as the connectivity between the embedded processor and the remote processor, etc. In box 606, a comparison is made between the QoS metrics and the execution parameters to determine whether processing the task at the remote processor satisfies the QoS metrics of the task. In other words, the execution parameters are compared to QoS metrics for a_{(i,j)}=0. If the execution parameters meet the QoS metrics, then in box 608 the task is allocated to the remote processor. Otherwise in box 610, the Run-Time Offloading Manager 216 determines whether the execution parameters for the embedded processor meet the QoS metrics of the task. If the execution parameters for the embedded processor do meet the QoS metrics, then in box 612 the task is executed at the embedded processor. If the execution parameters for the embedded processor do not meet the QoS metrics for the task, then the flowchart passes to box 614 in which the task is not executed.

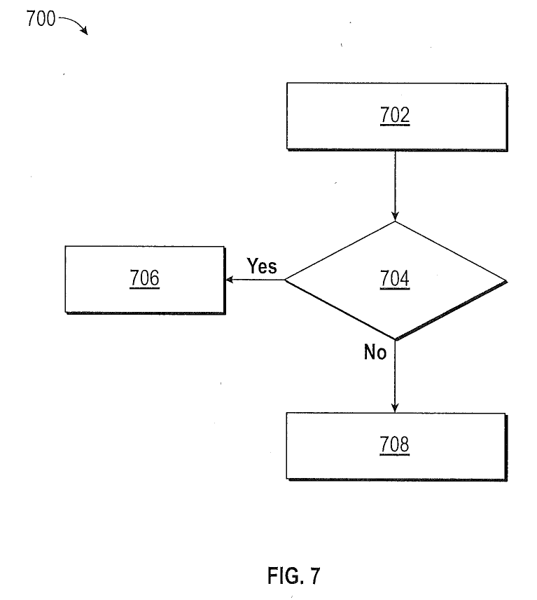

FIG. 7 shows a flow chart 700 illustrating a decision process for performing a task in the event that the task is currently being performed on the remote processor and a connection between the embedded processor and the remote processor is lost mid-task. In box 702, a signal is received indicating that the remote processor can no longer meet the quality-of-service metrics (latency, availability, reliability) for the computational task. The loss of quality-of-service can be due to a lost connection between the embedded processor and the remote processor or additional demands being placed on the remote processor. In box 704, the local controller then determines whether the resources of the embedded processor are sufficient to resume execution of the task locally. If the resources are available at the embedded processor, the flowchart proceeds to box 706. In box 706, the task is executed at the embedded processor. If the resources are not available at the embedded process, the flowchart proceeds to box 708. In box 708, the task is not executed at embedded processor. Instead, the embedded processor initiates a mitigation mode that allows the vehicle to reach a safe state, which can involve requesting the human driver to take over full control of the vehicle or changing a mode in the vehicle to automatically reach the minimal risk condition. For a non-run-to-complete task, the embedded processor can store existing or buffered results of the task that occurred before the failure of the remote processor.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the disclosure not be limited to the particular embodiments disclosed, but will include all embodiments falling within the scope of the application.

What is claimed is:

1. A method of operating a vehicle, comprising:
receiving, at an embedded processor of the vehicle, a computational task involving an operation of the vehicle;
offloading the computational task from the embedded processor to the remote processor;
performing the computational task at the remote processor to obtain a partial result;
providing the partial result to the embedded processor; and
performing the computational task at the embedded processor starting with the partial result provided by the remote processor.

2. The method of claim 1, further comprising
determining, at the embedded processor, a quality-of-service metric for the computational task;
determining, at the embedded processor, an execution parameter for performing the computational task at a remote processor; and
offloading the computational task from the embedded processor to the remote processor when the execution parameter of the remote processor meets the quality-of-service metric for the computational task.

3. The method of claim 2, further comprising performing the computational task at the embedded processor when the execution parameter of the remote processor does not meet the quality-of-service metric for the computational task.

4. The method of claim 2, wherein the quality-of-service metric further comprises at least one of a reliability metric, a latency metric, and an accuracy metric for the computational task.

5. The method of claim 2, wherein determining the execution parameter of the remote processor further comprises determining a latency of a communication link between the embedded processor and the remote processor.

6. The method of claim 2, further comprising performing the computational task at the embedded processor when an execution parameter of the remote processor fails to meet the quality-of-service metric for the computational task while the remote processor is performing the computational task.

7. A computer system for driving a vehicle, comprising:
an embedded processor of the vehicle configured to:
receive a computational task involving an operation of the vehicle, and
offload the computational task; and
a remote processor configured to:
receive the offloaded computational task from the embedded processor,
perform the computational task to obtain a partial result, and
provide the partial result to the embedded processor;
wherein the embedded processor is further configured to perform the computational task using the partial result provided by the remote processor.

8. The computer system of claim 7, wherein the embedded processor is further configured to:
determine a quality-of-service metric for the computational task,
determine an execution parameter for performing the computational task at the remote processor, and
offload the computational task to the remote processor when the execution parameter of the remote processor meets the quality-of-service metric for the computational task.

9. The computer system of claim 8, wherein the embedded processor is further configured to perform the computational task when the execution parameter of the remote processor does not meet the quality-of-service metric for the task.

10. The computer system of claim 8, wherein the quality-of-service metric further comprises at least one of a reliability metric, a latency metric, and an accuracy metric for the computational task.

11. The computer system of claim 8, wherein the execution parameter of the remote processor further comprises a latency of a communication link between the embedded processor and the remote processor.

12. The computer system of claim 8, wherein the embedded processor performs the computational task when an execution parameter of the remote processor fails to meet the quality-of-service metric for the computational task while the remote processor is performing the computational task.

13. The computer system of claim 8, wherein the remote processor is one of: a cloud server; a portable processor being carried within the vehicle; an embedded processor of another vehicle.

14. A vehicle, comprising:
an embedded processor configured to:
receive an instruction to perform a computational task involving an operation of the vehicle;
offload the computer task to a remote processor;
receive a partial result of the computational task from the remote processor, and
perform the computational task starting with the partial result provided by the remote processor.

15. The vehicle of claim 14, wherein the embedded processor is further configured to:
determine a quality-of-service metric for the computational task,
determine an execution parameter of a remote processor for performing the computational task at the remote processor, and
offload the computational task to the remote processor when the execution parameter of the remote processor meets the quality-of-service metric for the computational task.

16. The vehicle of claim 15, wherein the embedded processor is further configured to perform the computational task when the execution parameter of the remote processor does not meet the quality-of-service metric for the computational task.

17. The vehicle of claim 15, wherein the quality-of-service metric further comprises at least one of a reliability metric, a latency matric, and an accuracy metric for the computational task.

18. The vehicle of claim 15, wherein the execution parameter of the remote processor further comprises a latency of a communication link between the embedded processor and the remote processor.

19. The vehicle of claim 15, wherein the embedded processor is further configured to quantify a mission-criticality of the computational task to the vehicle and offload the computational task when the associated mission-criticality meets a selected criterion.

20. The vehicle of claim 15, wherein the remote processor is one of: a cloud server; a portable processor being carried within the vehicle; an embedded processor of another vehicle.
